(19) United States
(12) Patent Application Publication
(10) Pub. No.: US 2016/0133937 A1
(43) Pub. Date: May 12, 2016

(54) NEGATIVE ELECTRODE MEMBRANE AND LITHIUM ION BATTTERY USING THE SAME

(71) Applicant: Dongguan Amperex Technology Limited, Dongguan City (CN)

(72) Inventors: Cao ZHENG, Dongguan City (CN); Zheng QIANG, Dongguan City (CN); Wang SHENGWEI, Dongguan City (CN); Sun CHENGDONG, Dongguan City (CN); Shen HONGGUANG, Dongguan City (CN); Gao CHAO, Dongguan City (CN)

(21) Appl. No.: 14/929,172

(22) Filed: Oct. 30, 2015

(30) Foreign Application Priority Data
Nov. 6, 2014 (CN) 201410624755.9

(51) Int. Cl. H01M 4/62; H01M 4/133; H01M 4/485; H01M 4/38; H01M 4/587; H01M 4/131; H01M 4/134

(52) U.S. Cl. CPC H01M 4/622; H01M 4/131; H01M 4/133; H01M 4/134; H01M 4/387; H01M 4/587; H01M 4/386; H01M 4/485; H01M 2004/027

(57) ABSTRACT

The present application provides a negative electrode membrane containing a negative electrode active substance, a conductive agent, a binder and a thickener, wherein the mass percent content of the binder in the negative electrode membrane does not exceed 2%, and the binder contains a polymer formed of a styrene monomer, an acrylate-based monomer and an acrylic acid-based monomer. The negative electrode membrane has small content of binders and good ion conductivity performance; with the usage of the negative electrode membrane in a Lithium ion battery, in cases of high-rate fast charging, it is possible to avoid lithium to precipitate on a surface of the negative electrode sheet, and the Lithium ion battery may have good safety and cycle performance.

### TECHNICAL FIELD

The present application relates to the technical field of lithium ion battery, and particularly to a lithium ion battery that can be fast charged at high rates and its negative electrode sheet.

### BACKGROUND

Lithium ion batteries, due to their advantages such as high energy density, high working voltage, long life time, no memory effect and being environment friendly, have become ideal power supplies for mobile devices and replaced conventional power supplies. With the intellectualization and multifunctionalization of mobile devices, their power consumptions are increased dramatically, thus raising higher demands on energy densities of lithium ion batteries.

Since lithium ion batteries based on graphite were developed by Sony in 1991, after more than two decades of development, their energy densities have approached the limit. However, some key problems still remain unsolved in the development of new chemical systems, such as pulverization of silicon-based negative electrode active materials per se resulted from swelling after cycles, poor high temperature cycle performance of positive electrode active materials at high voltages, poor stability of electrolytic solutions at high-voltage systems, gas generation resulted from reactions of positive electrode active materials with electrolytic solutions and the like.

There are troubles in improvement of energy densities, in order to improve Customers experiences, the development of high-rate fast charged lithium ion batteries can make up for poor energy densities to some extent. But when a lithium ion battery is fast charged at high rates, the lithium ion battery is severely polarized, with an increase in current per unit area, its negative electrode reaches Li precipitation potential quickly, thus plenty of Li ions diffusing from the positive electrode to the negative electrode cannot be accepted by the negative electrode, then Li dendrites are precipitated on the surface of the negative electrode, thereby reducing fast the capacity of the battery; furthermore, the Li dendrites tend to pierce the separating membrane, thereby resulting in serious potential safety hazards.

At present, styrene-butadiene rubber (SBR) is generally used as a binder in an aqueous negative electrode sheet of a lithium ion battery, the binder has excellent elasticity and good binding power, but its ion-conducting performance is poor, thus it cannot implement high-rate fast charging.

### SUMMARY

According to an aspect of the present application, there is provided a negative electrode membrane in which the content of binders is small and which has good ion conductivity performance; with the usage of the negative electrode membrane in a lithium ion battery, in cases of high-rate fast charging, it is possible to avoid lithium to precipitate on a surface of the negative electrode sheet, and the lithium ion battery may have good safety and cycle performance.

The negative electrode membrane comprises a negative electrode active substance, a conductive agent, a binder and a thickener, wherein the mass percent content of the binder in the negative electrode membrane does not exceed 2%, and the binder contains a polymer formed of a styrene monomer, an acrylate-based monomer and an acrylic acid-based monomer.

Preferably, the acrylate-based monomer has a chemical structural formula as shown by Formula (I) and the acrylic acid-based monomer has a chemical structural formula as shown by Formula (II);

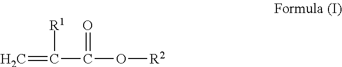

in Formula (I), R¹ is selected from hydrogen, alkyls containing 1 to 20 carbon atoms, and R² is selected from alkyls containing 1 to 20 carbon atoms;

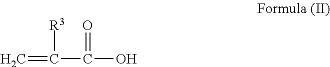

in Formula (II), R³ is selected from hydrogen, alkyls containing 1 to 20 carbon atoms.

Preferably, R¹ in Formula (I) is selected from hydrogen, alkyls containing 1 to 10 carbon atoms.

Preferably, R³ in Formula (II) is selected from hydrogen, alkyls containing 1 to 10 carbon atoms.

Preferably, the negative electrode membrane consists of the negative electrode active substance, the conductive agent, the binder and the thickener.

The alkyls are radicals obtained by removal of any hydrogen atom from any straight alkyl molecular, any alkyl molecular containing branches or any cycloalkane molecular.

Preferably, the acrylate-based monomer is selected from at least one of methyl acrylate, ethyl acrylate, butyl methacrylate and butyl acrylate; and the acrylic acid-based monomer is selected from at least one of an acrylic acid, a methacrylic acid and an ethylacrylic acid.

Preferably, the mass percent content of the binder in the negative electrode membrane is 0.5-2%. Further preferably, the mass percent content of the binder in the negative electrode membrane is 1-2%. The binder has great adhesive force, good ion-conducting performance, thereby reducing greatly polarization of the surface of the positive electrode.

Preferably, the mass percent content of the styrene monomer in total monomers is 10-40%. Further preferably, in the binder, the mass percent content of the styrene monomer in total monomers has a range with its upper limit selected optionally from 35%, 30% and 25% and with its lower limit selected optionally from 12% and 15%. The usage of the styrene monomer can improve the cohesion of polymers in the binder, thus increasing the binding force of the binder.

Preferably, the mass percent content of the acrylate-based monomer in total monomers is 50-85%. Further preferably, the mass percent content of the acrylate-based monomer in total monomers has a range with its upper limit selected optionally from 85%, 82%, 80% and 78% and with its lower limit selected optionally from 60%, 65%, 70% and 72%. The usage of the acrylate-based monomer ensures binding between particles of the active substance in the electrode membrane and a foil of a current collector of the electrode sheet, and a complexation-decomplexation process of lone-pair electrons in carbonyls of the acrylate with Li ions under the influence of an electric field makes the Li ions to transfer fast along a polymer chain, thus resulting in good conductivity.

Preferably, the mass percent content of the acrylic acid-based monomer in total monomers is 1-10%. Further preferably, the mass percent content of the acrylic acid-based monomer in total monomers has a range with its upper limit selected optionally from 8%, 7% and 6% and with its lower limit selected optionally from 2%, 3% and 4%. The introduction of a hydrophilic polar radical (carboxyl) into a lateral chain of the binder polymer makes it possible to reduce surface energy so that the emulsion is easy to form a membrane and the resulting membrane has high strength and strong attaching force, thereby further increasing the binding force of the binder.

Mass percent contents of respective monomers in total monomers=masses of respective monomers+(mass of styrene monomer+mass of acrylate-based monomer+mass of acrylic acid-based monomer)×100%. For example, mass percent content of styrene monomer in total monomers=mass of styrene monomer+(mass of styrene monomer+mass of acrylate-based monomer+mass of acrylic acid-based monomer)×100%.

Preferably, the negative electrode active substance is selected from at least one of graphite, mesocarbon microbeads (MCMB), hard carbon, soft carbon, Li₄Ti₅O₁₂, tin and silicon. Further preferably, the negative electrode active substance is graphite. Preferably, the mass percent content of the negative electrode active substance in the negative electrode membrane is no less than 90%. Further preferably, the mass percent content of the negative electrode active substance in the negative electrode membrane is no less than 95%.

Those skilled in the art can select suitable types and contents of conductive agents depending on practical requirements. Preferably, the conductive agent is selected from at least one of conductive carbon black, graphene and carbon nanotube. Preferably, the mass percent content of the conductive agent in the negative electrode membrane is 0-3%. Further preferably, the mass percent content of the conductive agent in the negative electrode membrane is 0-1.5%.

Those skilled in the art can select suitable types and contents of thickeners depending on practical requirements. Preferably, the thickener is selected from sodium carboxymethyl cellulose and/or polyacrylamide. Preferably, the mass percent content of the thickener in the negative electrode membrane is 0.8-3%. Further preferably, the mass percent content of the thickener in the negative electrode membrane is 0.8-1.5%.

Preferably, the binder further contains an emulsifier. Those skilled in the art can select suitable types and contents of emulsifiers depending on practical requirements. Preferably, the mass percent content of the emulsifier in the binder is 2-5%. Preferably, the emulsifier is disproportionated rosin acid soap and/or potassium oleate.

In addition, the binder further contains an unavoidable chain initiator for polymerization reaction. Those skilled in the art can select suitable types and contents of chain initiators and chain terminator depending on practical requirements.

As a preferred embodiment of the present application, a method for preparing the emulsion prior to solidification of the binder includes at least the following steps: adding styrene, an acrylate-based compound, an acrylic acid-based compound into an aqueous solution containing an emulsifier, and at a temperature not exceeding 30° C., adding an initiator to initiate polymerization reaction so as to obtain an emulsion with a solid content of 35 wt % to 55 wt %.

According to another aspect of the present application, there is further provided a lithium ion battery comprising at least one of the negative electrode membranes described above. The lithium ion battery has good safety and cycle performance in cases of high-rate fast charging.

Preferably, the Lithium ion battery is a wound lithium ion battery or a stacked lithium ion battery.

The lithium ion battery includes a positive electrode sheet, a negative electrode sheet, a separating membrane and an electrolyte or electrolytic solution, and the negative electrode sheet contains any negative electrode membrane described above and a current collector.

The present application has the following beneficial effects:

(1) The binder used in the negative electrode membrane according to the present application has good binding force and high ionic conductivity, thereby implementing high-rate fast charging of the lithium ion battery.

(2) With the usage of the negative electrode membrane according to the present application in a lithium ion battery, in cases of high-rate fast charging, it is possible to avoid lithium to precipitate on a surface of the negative electrode sheet.

(3) The lithium ion battery using the negative electrode membrane according to the present application has good safety and cycle performance.

### BRIEF DESCRIPTION OF THE DRAWINGS

FIG. 1 shows electrochemical impedance spectroscopies of lithium ion batteries C1 and C5; and

FIG. 2 is a diagram showing 2C charging cycle life of batteries C1 and C5.

### DETAILED DESCRIPTION

The present application is described hereinafter in detail with reference to accompanying drawings and examples, but the present application is not limited to these drawings and examples.

All ratios and parts in the examples are by weight.

### Example 1

### Preparation of Binder Emulsion Prior to Solidification of Binder

195 parts by weight of distilled water, 2.25 parts by weight of disproportionated rosin acid soap (emulsifier) and 2.25 parts by weight of potassium oleate (emulsifier) were added into a polymerization reactor where air was replaced by nitrogen. Then, 15 parts by weight of styrene, 41 parts by weight of butyl methacrylate, 41 parts by weight of ethyl acrylate and 3 parts by weight of methacrylic acid were added into the polymerization reactor, and the air in the reactor was replaced by nitrogen for 15 minutes. The temperature of the reactor was stabilized at 5-10° C., 0.9 part by weight of ammonium persulfate (initiator) was added, with the rotational speed of a stirrer being set at 100 r/min, and after polymerization for 8 hours, the binder emulsion was obtained.

Preparation of Negative Electrode Sheet N1

Artificial graphite (active substance), the binder emulsion, sodium carboxymethyl cellulose (thickener) and conductive carbon black (conductive agent) were mixed, and an evenly-dispersed mixture containing the negative electrode active substance was obtained after high-speed stirring. In the mixture, solid components included 95 wt % of artificial graphite, 1.5 wt % of sodium carboxymethyl cellulose, 1.5 wt % of conductive carbon black and 2 wt % of the binder. A slurry of the negative electrode active substance was prepared by using water as a solvent, and the solid content of the slurry was 50 wt %. The slurry was evenly applied on both sides of a copper foil, and the copper foil was dried and pressed by a roll squeezer to obtain a negative electrode sheet denoted as N1.

Preparation of Positive Electrode Sheet P1

Lithium cobaltate (LiCoO₂, positive electrode active substance), PVDF (Polyvinylidene Fluoride, binder) and conductive carbon black were mixed, and an evenly-dispersed mixture containing the positive electrode active substance was obtained after high-speed stirring. In the mixture, solid components included 90 wt % of lithium cobaltate, 5 wt % of PVDF and 5 wt % of conductive carbon black. A slurry of the positive electrode active substance was prepared by using NMP (N-methyl Pyrrolidinone) as a solvent, and the solid content of the slurry was 75 wt %. The slurry was evenly applied on both sides of an aluminum foil, and the aluminum foil was dried and pressed by a roll squeezer to obtain a positive electrode sheet denoted as P1.

Preparation of Lithium Ion Battery C1

A conductive electrode tab was welded on the positive electrode sheet P1 and the negative electrode sheet N1, a 14 um polypropylene/polyethylene composite separating membrane (PP/PE composite separating membrane) was sandwiched between the positive electrode and negative electrode, and the resulting structure was wound to form a bare cell that is then packaged with aluminum-plastic film. An electrolytic solution containing 1M of lithium hexafluorophosphate was used as the electrolytic solution, and the solvent was a solvent mixed from ethylene carbonate/dimethyl carbonate/1,2 propylene glycol carbonate with a volume ratio of 1:1:1. After packaging, the battery was formed and aged to obtain a soft-packaged battery with a dimension of 32 mm (length)×82 mm (width)×42 mm (thickness).

### Example 2

The preparation of a binder emulsion prior to solidification of the binder was the same as that in Example 1, and differences included: 12 parts by weight of styrene, 42 parts by weight of butyl methacrylate, 43 parts by weight of ethyl acrylate and 3 parts by weight of methacrylic acid were used as monomers.

The preparation of the negative electrode sheet was the same as that in Example 1, and the differences included: in the slurry of mixture, solid components included 96 wt % of artificial graphite, 1.5 wt % of sodium carboxymethyl cellulose, 1.5 wt % of conductive carbon black and 1 wt % of the binder. The obtained negative electrode sheet was denoted as N2.

P1 was used as the positive electrode and N2 was used as the negative electrode, with other conditions being the same as those in Example 1, to obtain a lithium ion battery denoted as C2.

### Example 3

The preparation of a binder emulsion prior to solidification of the binder was the same as that in Example 1, and differences included: during the preparation of the binder emulsion prior to solidification of the binder, 25 parts by weight of styrene, 36 parts by weight of methyl acrylate, 36 parts by weight of butyl acrylate and 3 parts by weight of methacrylic acid were used as monomers.

The preparation of the negative electrode sheet was the same as that in Example 1, and the obtained negative electrode sheet was denoted as N3.

P1 was used as the positive electrode and N3 was used as the negative electrode, with other conditions being the same as those in Example 1, to obtain a lithium ion battery denoted as C3.

### Example 4

Other conditions were the same as those in Example 1, and differences included: during the preparation of the binder emulsion prior to solidification of the binder, 15 parts by weight of styrene, 39 parts by weight of methyl acrylate, 39 parts by weight of butyl acrylate, 3 parts by weight of acrylic acid and 4 parts by weight of ethylacrylic acid were used as monomers.

The preparation of the negative electrode sheet was the same as that in Example 1, and the obtained negative electrode sheet was denoted as N4.

P1 is used as the positive electrode and N4 was used as the negative electrode, with other conditions being the same as those in Example 1, to obtain a lithium ion battery denoted as C4.

### Comparative Example 1

Other conditions were the same as those in Example 1, and differences included: there is no step of preparing the binder emulsion, a conventional styrene-butadiene rubber (SBR) was used to prepare the negative electrode sheet, other conditions were the same as those in Example 1, and the obtained negative electrode sheet was denoted as N5.

P1 was used as the positive electrode and N5 was used as the negative electrode, with other conditions being the same as those in Example 1, to obtain a lithium ion battery denoted as C5.

### Example 5

### Test on Binding Force of Negative Electrode Sheet

After negative electrode sheets N1 to N5 were cold pressed, binding forces of the negative electrode sheets N1 to N5 were tested respectively on a Gotech AI-3000 tensile testing machine. After the negative electrode sheets N1 to N5 were soaked in an electrolytic solution at 60° C. for 96 hours, their binding forces were tested again. An electrolytic solution containing 1M of lithium hexafluorophosphate was used as the electrolytic solution, and the solvent was a solvent mixed from ethylene carbonate/dimethyl carbonate/1,2 propylene glycol carbonate with a volume ratio of 1:1:1.

Table 1 shows types of monomers in the binders of the negative electrode sheets N1 to N5, mass percent contents of respective monomers in total monomers and respective binding force testing results. It can be seen from the table that compared to the negative electrode sheet N5 in the comparison example 1, binding forces of the negative electrode sheets N1 to N4 of the electrode membrane according to the present application are improved significantly.

TABLE 1

| | Mass | | Types of | Types of | Binding | Binding |
|---|---|---|---|---|---|---|
| | percent | Mass | acrylate-based | acrylic | force after | force after |
| Negative | content of | percent | monomers, | acid-based | being | being soaked |
| electrode | styrene | content of | mass percent | monomers, | cold | in electrolytic |
| sheet | monomer | butadiene | content | mass percent | pressed | solution |
| No. | (%) | (%) | (%) | content (%) | (N/m) | (N/m) |
| N1 | 15 | 0 | butyl | methacrylic | 30 | 25 |
| | | | methacrylate, 41 | acid, 3 | | |
| | | | ethyl | | | |
| | | | acrylate, 41 | | | |
| N2 | 12 | 0 | butyl | methacrylic | 35 | 20 |
| | | | methacrylate, 42 | acid, 3 | | |
| | | | ethyl | | | |
| | | | acrylate, 43 | | | |
| N3 | 25 | 0 | methyl | methacrylic | 24 | 18 |
| | | | acrylate, 36 | acid, 3 | | |
| | | | butyl | | | |
| | | | acrylate, 36 | acrylic | | |
| N4 | 15 | 0 | methyl | acid, 3 | 34 | 24 |
| | | | acrylate, 39 | | | |
| | | | butyl | ethylacrylic | | |
| | | | acrylate, 39 | acid, 4 | | |
| N5 | 15 | 85 | 0 | 0 | 20 | 12 |

### Example 6

### Test on Lithium Precipitation on Negative Electrode

At 25° C., lithium ion batteries C1 to C4 obtained in Examples 1 to 4 and the lithium ion battery C5 obtained in the Comparison Example were charged respectively, in constant current mode at 2C rate, to 4.35 V, then charged in constant voltage mode at 4.35 V with a cut-off current of 0.05 C, and then discharged in constant current mode at 1C rate with a cut-off voltage of 3 V, this was one charge-discharge cycle process, and such a charge-discharge cycle process was repeated for 10 times. After the repetition ended, the battery was fully charged, the cell was disassembled, and then an IRIS Advantage full spectrum Inductively Coupled Plasma (ICP) spectrometer was used to measure whether there was lithium precipitated on a surface of a negative electrode sheet, and the results were shown in Table 2.

TABLE 2

| | Lithium |
|---|---|
| | precipitation |
| Battery No. | status |
| C1 | No lithium |
| | precipitation |
| C2 | No lithium |
| | precipitation |
| C3 | Slight lithium |
| | precipitation |
| C4 | No lithium |
| | precipitation |
| C5 | Severe lithium |
| | precipitation |

### Example 7

### Electrochemical Impedance Scanning

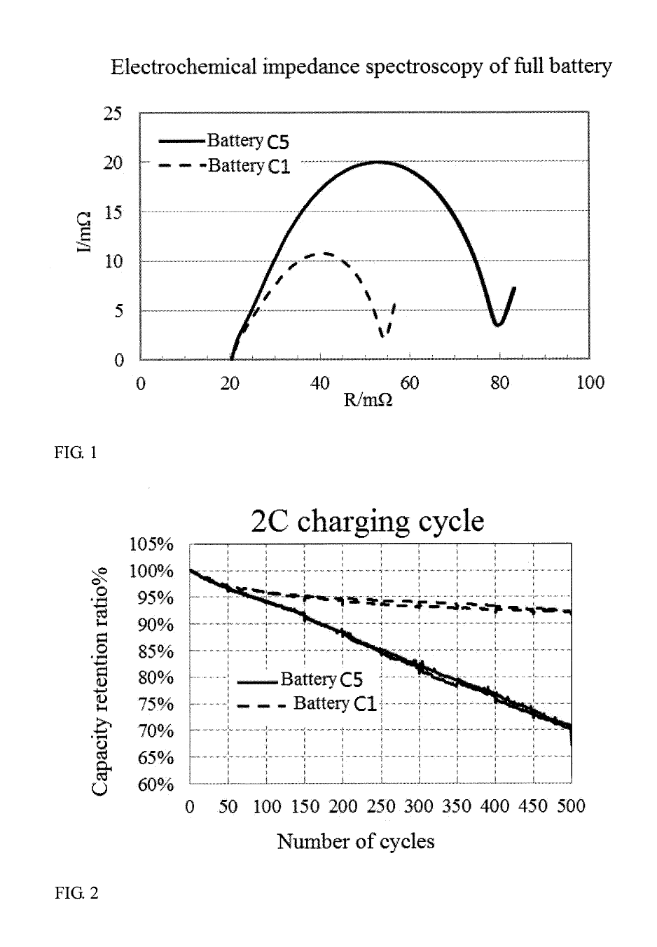

An IM6ex electrochemical all-purpose tester was used to perform, at normal temperature in a semi-charged state, electrochemical impedance scanning on the lithium ion batteries C1 to C4 obtained in Examples 1 to 4 and the lithium ion battery C5 obtained in the comparison example. In C1 to C4 using the technical solution according to the present application, C1 was taken as a typical example, and its electrochemical impedance spectroscopy and an electrochemical impedance spectroscopy of C5 obtained in Comparative Example 1 were shown in FIG. 1. It could be seen from the figure that compared to C5, the conduction velocity of Li ions in the negative electrode of C1 was improved significantly.

### Example 8

### Test on Cycle Performance of Battery

At 25° C., lithium ion batteries C1 to C4 obtained in Examples 1 to 4 and the lithium ion battery C5 obtained in the comparison example were charged, in constant current mode at 2C rate, to 4.35 V, then charged in constant voltage mode at 4.35 V with a cut-off current of 0.05C, and then discharged in constant current mode at 1C rate with a cut-off voltage of 3V, this was one charge-discharge cycle process, and such a charge-discharge cycle process is repeated for 500 times.

Capacity retention ratio of an nth cycle (%)=(discharge capacity of the nth cycle/discharge capacity of the first cycle)×100%.

In C1 to C4 using the technical solution according to the present application, C1 was taken as a typical example, and the capacity retention ratio obtained during its cycle process and the capacity retention ratio of C5 obtained in the comparison example 1 are shown in FIG. 2. With same numbers of cycles, the capacity retention ratios of C2 to C4 during cycles=capacity retention ratio of C1×(1±10%).

It could be seen from FIG. 2 that compared to the battery C5 obtained in the comparison example 1, the life time of the battery C1 using the technical solution according to the present application was improved significantly.

Described above are merely preferable examples of the present application and are not intended to limit the present application, and numerous modifications and variations will be apparent to those skilled in the art. All modifications, replacements and improvements made within the spirit and principles of the present application shall be covered within the projection scope of the present application.

What is claimed is:

1. A negative electrode membrane, comprising a negative electrode active substance, a conductive agent, a binder and a thickener, wherein the mass percent content of the binder in the negative electrode membrane does not exceed 2%, and the binder contains a polymer formed of a styrene monomer, an acrylate-based monomer and an acrylic acid-based monomer.

2. The negative electrode membrane according to claim 1, wherein the acrylate-based monomer has a chemical structural formula as shown by Formula (I) and the acrylic acid-based monomer has a chemical structural formula as shown by Formula (II): 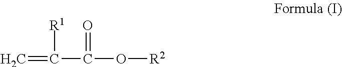
in Formula (I), R¹ is selected from hydrogen, alkyls containing 1 to 20 carbon atoms, and R² is selected from alkyls containing 1 to 20 carbon atoms; and 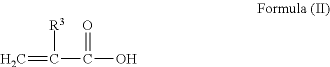
in Formula (II), R³ is selected from hydrogen, alkyls containing 1 to 20 carbon atoms.

3. The negative electrode membrane according to claim 1, wherein the acrylate-based monomer is selected from at least one of methyl acrylate, ethyl acrylate, butyl methacrylate and butyl acrylate; and the acrylic acid-based monomer is selected from at least one of an acrylic acid, a methacrylic acid and an ethylacrylic acid.

4. The negative electrode membrane according to claim 1, wherein the mass percent content of the styrene monomer in total monomers is 10-40%; the mass percent content of the acrylate-based monomer in total monomers is 50-85%; and the mass percent content of the acrylic acid-based monomer in total monomers is 1-10%.

5. The negative electrode membrane according to claim 1, wherein the negative electrode active substance is selected from at least one of graphite, mesocarbon microbeads, hard carbon, soft carbon, Li₄Ti₅O₁₂, tin and silicon.

6. The negative electrode membrane according to claim 1, wherein the negative electrode active substance is at least one of natural graphite, artificial graphite, mesocarbon microbeads, hard carbon, soft carbon, Li₄Ti₅O₁₂, tin and silicon.

7. The negative electrode membrane according to claim 1, wherein the conductive agent is selected from at least one of conductive carbon black, graphene and carbon nanotube.

8. The negative electrode membrane according to claim 1, wherein the thickener is selected from sodium carboxymethyl cellulose and/or polyacrylamide.

9. The negative electrode membrane according to claim 1, wherein the mass percent content of the binder in the negative electrode membrane is 0.5-2%.

10. A lithium ion battery, comprising at least one of the negative electrode membranes according to claim 1.
